(19) United States
(12) Patent Application Publication
(10) Pub. No.: US 2011/0199039 A1
(43) Pub. Date: Aug. 18, 2011

(54) Fractional boost system

(76) Inventor: Geoffrey B. Lansberry, Andover, MA (US)

(21) Appl. No.: 12/658,891

(22) Filed: Feb. 17, 2010

(51) Int. Cl. G05B 11/32; G05F 1/10

(52) U.S. Cl. 318/625; 323/284

(57) ABSTRACT

A fractional boost system including a boost converter, responsive to the base level voltage of a power supply, for providing a boost level voltage to a load and a control system for sensing the current to the boost converter and limiting the boost function of the boost converter when the current to the boost converter exceeds a predetermined level, while applying the power supply base level voltage and supplying current exceeding the predetermined level to the load.

### FIELD OF THE INVENTION

This invention relates to a fractional boost system and more particularly to such a fractional boost system adapted for operating motors and motor drives especially in mobile robots.

### BACKGROUND OF THE INVENTION

Generally mobile robots are desired to be as light and inexpensive as permissible. One source of weight and cost are the one or more motors and motor drives that operate the robot. One way to reduce the size and cost of the motors and drives is to use motors with increased voltage and hence lower current ratings. One problem with this is that the higher voltage motors require higher voltage batteries which are less reliable and are more difficult to charge. Further, in many applications the power supply voltages are already standardized at some level e.g. 36 volts. Another approach is to choose higher voltage motors, but utilize field weakening of the motors so that at high speeds they don't need the high voltages but these controllers are not commercially, freely, available and some classes of motors cannot be sufficiently field weakened to obtain worthwhile results. Further, on failure the voltage can return to high voltage which can damage the electronic controls and battery. Another approach is to simply add a full boost converter to obtain a higher voltage intermediate bus commensurate with the higher voltage rated motor. However, this requires a second power supply or DC/DC converter able to supply the full rated voltage and current which adds substantial size, weight and cost.

### SUMMARY OF THE INVENTION

It is therefore an object of this invention to provide an improved motor drive with a fractional boost system.

It is a further object of this invention to provide such an improved fractional boost system which is smaller, lighter, more efficient and less costly.

It is a further object of this invention to provide such an improved fractional boost system for use with motors and motor drives.

It is a further object of this invention to provide such an improved fractional boost system which allows for lower cost, lower size and weight motor and motor drives.

It is a further object of this invention to provide such an improved fractional boost system which permits high speed operation and low current operation of a motor while preserving high torque operation at low speed.

It is a further object of this invention to provide such an improved fractional boost system which eliminates the need for high voltage batteries.

It is a further object of this invention to provide such an improved fractional boost system which adds only the minimum required amount of power conversion.

It is a further object of this invention to provide such an improved fractional boost system which is fault tolerant, e.g. recovery of mobile robots even if there is a failure in the boost converter.

It is a further object of this invention to provide such an improved fractional boost system which can provide a continuum of complementary torque/speed (current/voltage) ratios.

It is a further object of this invention to provide such an improved fractional boost system which can be selectively enabled/disabled to improve efficiency.

The invention results from the realization that in some cases full power, full voltage and current, are not needed at all times, indeed in some applications high voltage and high current are not needed simultaneously, that is operation at high speed (voltage) with high torque (current) is not a requirement and therefore a fractional boost system with much less size, weight and cost can work well by using a boost converter, responsive to the base level voltage of a power supply, for providing a boost level voltage to a load and a control system for sensing the current to the boost converter and limiting the boost function of the boost converter when the current in the boost converter exceeds a predetermined level, while applying the power supply base level voltage and supplying current exceeding the predetermined level to the load.

The subject invention, however, in other embodiments, need not achieve all these objectives and the claims hereof should not be limited to structures or methods capable of achieving these objectives.

This invention features a fractional boost system including a boost converter, responsive to the base level voltage of a power supply, for providing a boost level voltage to a load and a control system for sensing the current to the boost converter and limiting the boost function of the boost converter when the current to the boost converter exceeds a predetermined level, while applying the power supply base level voltage and supplying current exceeding the predetermined level to the load.

In preferred embodiment the control system may disable the boost function of the boost converter when the current to the boost converter exceeds the predetermined level while enabling the boost converter to apply the power supply base level voltage and supply current exceeding the predetermined level to the load. The control system may limit the current to the boost converter to no more than the predetermined current level while providing additional current to the load from the power supply at the base level voltage. The control system may include a switch device in parallel with the boost converter for enabling current flow from the power supply only when the boost level voltage decreased below the base level voltage. The control system may include a current sensor for sensing the current to the boost converter and a first comparator for determining whether the current to the boost converter exceeds the predetermined level. The control system may include a voltage sensor for sensing the voltage at the load and a second comparator circuit for determining any difference between the voltage at the load and the boost level voltage. The control system may include a proportional integral derivative circuit responsive to the second comparator circuit for providing an output representative of any the difference between the voltage at the load and the boost level voltage. There may be a pulse width modulator responsive to the first and second comparator for setting the duty cycle of the boost converter. The load may include a motor drive. The load may include a number of motor drives. The motor drive(s) may be in a mobile robot.

This invention also features a fractional boost system for a motor drive including a boost converter, responsive to the base level voltage of a power supply, for providing a boost level voltage to a load and a control system for sensing the current to the boost converter and limiting the boost function of the boost converter when the current to the boost converter exceeds a predetermined level, while applying the power supply base level voltage and supplying current exceeding the predetermined level to the load.

This invention also features a fractional boost system operating one or more motor drives of a remote controlled mobile robot including a boost converter, responsive to the base level voltage of a power supply, for providing a boost level voltage to a load and a control system for sensing the current to the boost converter and limiting the boost function of the boost converter when the current to the boost converter exceeds a predetermined level, while applying the power supply base level voltage and supplying current exceeding the predetermined level to the load.

This invention also features a fractional boost system for a motor drive including a boost converter, responsive to the base level voltage of a power supply, for providing a boost level voltage to a load and a control system for sensing the current to the boost converter and limiting the boost function of the boost converter when the current to the boost converter exceeds a predetermined level, while applying the power supply base level voltage and supplying current exceeding the predetermined level to the load. The control system disables the boost function of the boost converter when the current to the boost converter exceeds the predetermined level while enabling the boost converter to apply the power supply base level voltage and supply current exceeding the predetermined level to the load.

This invention also features a fractional boost system operating one or more motor drives of a remote controlled mobile robot including a boost converter, responsive to the base level voltage of a power supply, for providing a boost level voltage to a load and a control system for sensing the current to the boost converter and limiting the boost function of the boost converter when the current to the boost converter exceeds a predetermined level, while applying the power supply base level voltage and supplying current exceeding the predetermined level to the load. The control system limits the current to the boost converter to no more than the predetermined current level while providing additional current to the load from the power supply at the base level voltage.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a diagrammatic view of a mobile robot employing a fractional boost system according to this invention to operate one or more motor drives and motors;

FIG. 2 is a more detailed schematic diagram of the fractional boost system of FIG. 1;

FIG. 3 illustrates a number of voltage and current waveforms occurring in the fractional boost system of FIG. 2;

FIG. 4 illustrates speed and torque characteristics during different phases of operation of the motors drives by the fractional boost system of FIG. 2;

FIG. 5 is a more detailed schematic block diagram of the control system of FIG. 2;

FIG. 6 is a view similar to FIG. 2 of another embodiment of a fractional boost system according to this invention; and

FIG. 7 is a block diagram illustrating the fractional boost system of this invention operating a number of motor drives and motors.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

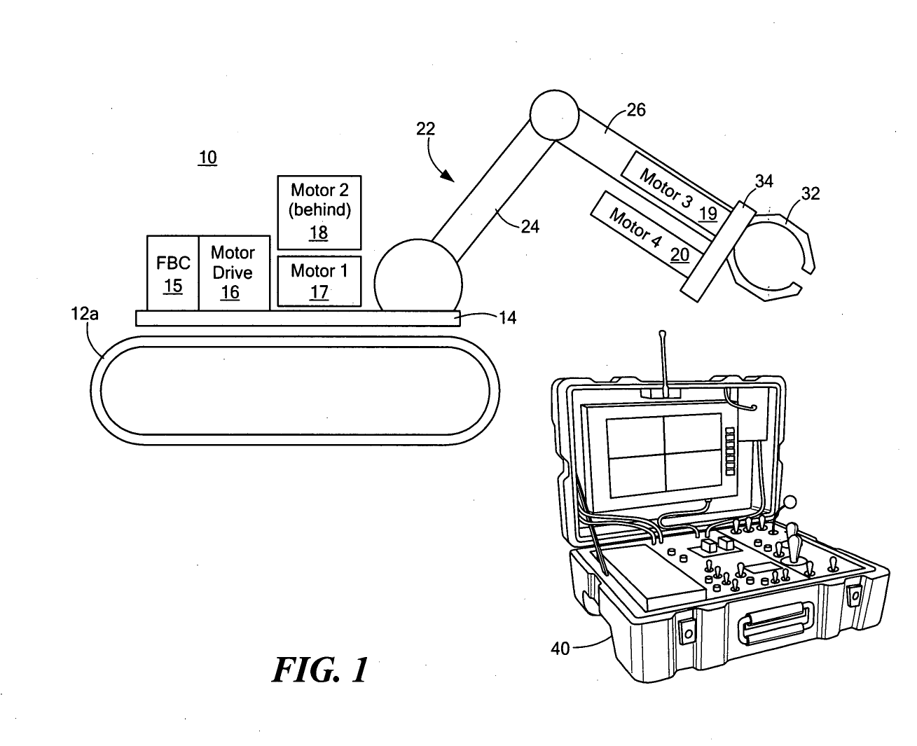

FIG. 1 shows a mobile, remotely controlled robot 10 driven by tracks 12a and (12b not shown) in accordance with one particular example of a robot in accordance with the subject invention. Robot 10 includes a turret 14 which carries a fractional boost system 15 according to this invention which drives motor drive 16 which in turn drives motor 17, 18, 19, and 20. Turret 14 also includes arm assembly 22 having lower arm 24 and upper arm 26. Lower arm 24 is able to pitch up and down but it does not turn. Upper arm 26 pitches with respect to lower arm 24 and is driven by a chain drive extending along lower arm 24. End effector 32 rotates via wrist 34. Motor 17 operates lower arm 24; motor 18 operates upper arm 26; motor 19 rotates wrist 34 and motor 20 operates end effector 32. Operator control unit 40 is used to wirelessly control robot 10 as is known in the art.

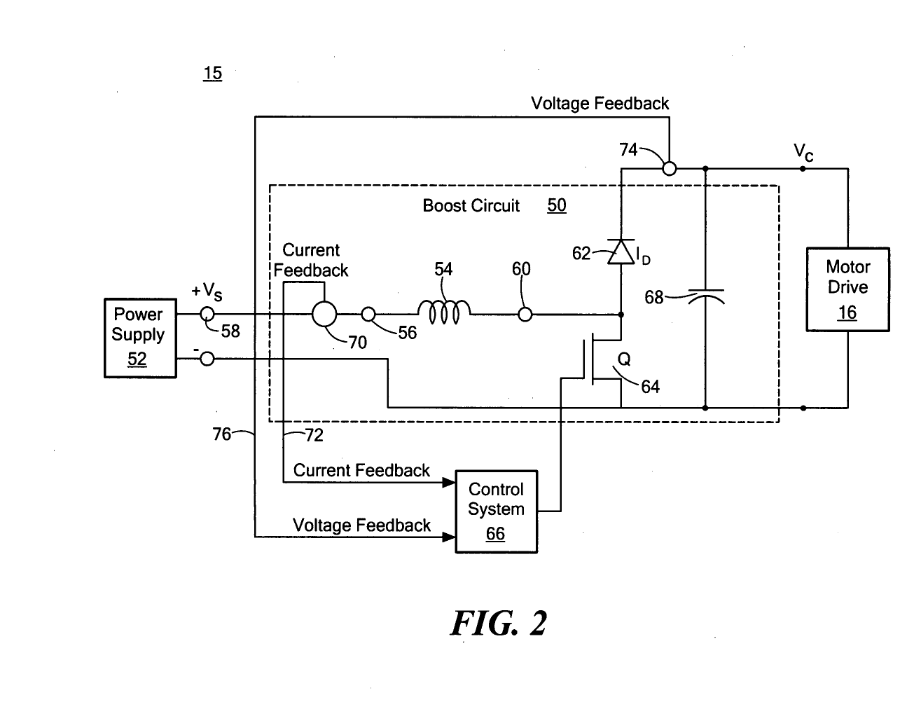

There is shown in FIG. 2 a fractional boost system 15 according to this invention which includes a boost converter 50 adapted for connection to a power supply 52, such as a battery, for example, which provides a base level voltage of e.g. 36 volts. Boost converter 50 includes an inductor 54 whose input end 56 is connected to the positive terminal 58 of power supply 52 at voltage Vₛ e.g. 36 volts. The output 60 of inductor 54 is connected to unidirectional switch 62 which may be simply a diode and also to chopping transistor 64. Chopping transistor 64 is operated by control system 66. The output of boost converter 50 is presented at capacitor 68 which provides the output to motor drive 16.

Control system 66 includes a current sensor 70 which senses the current to boost converter 50 and feeds that information back on line 72 to control system 66. Control system 66 also includes a voltage sensor 74 which feeds back the voltage V_{c} sensed across capacitor 68 in motor drive 16 on line 76 to control system 66. Boost converter 50 thus responds to the base level voltage e.g. 36 volts of power supply 52 and provides a boost level voltage e.g. 72 volts, V_{c}, to the load or motor drive 16. Normally at low loads, that is low torque and low current, the system operates in this boost level voltage mode wherein control system 66 selectively turns off transistor 64 allowing the voltage and magnetic field across inductor 54 to build up positive at input 56 negative at output 60. Then control system 66 turns off transistor 64 ceasing the charging of inductor 54 and causing the magnetic field to collapse and induce a reverse voltage which is positive at output terminal 60 and negative at input terminal 56 to be applied to the anode of diode 62. This turning on and off or chopping by transistor 64 continues unless the current to the boost converter exceeds a predetermined level as sensed by current sensor 70. When that happens control system 66 turns off transistor 64 and leaves it off. Power supply 52 is now connected directly through inductor 54, which is essentially zero impedance to d.c., through diode 62 to capacitor 68 and motor drive 16. As soon as the voltage on capacitor 68 connected to the cathode of diode 62 drops below the voltage on the anode, which in this case is the power supply voltage plus Vₛ, e.g. 36 volts, current begins to flow from the power supply 52 and can now exceed the current limit imposed by control system 66, but at 36 volts. Diode 62 is sized approximately for the current of inductor 54.

Until the boost converter exceeds the predetermined limit, the system operates with control system 66 alternately turning on and turning off transistor 64. However, in order to maintain the proper boost level voltage V_{c} on capacitor 68 in motor drive 16 the voltage sensor 74 feeds back its signal on line 76 to control system 66 to vary the duty cycle of transistor 64. If that voltage V_{c} falls below the desired voltage, control system 66 will increase the on time of transistor 64. If the voltage V_{c} goes above the boost level voltage, control system 66 will decrease the on time of transistor 64. Boost converter 50 is shown simply schematically and its particular configuration is not a part of this invention as any boost converter can be used in its place. The combination of the current sensor 70 and feedback line 72 with control system 66 supervising the operation of the boost converter at higher voltage allows lower cost and lower size and weight motors and motor drives to be used. It also permits high speed operation and low current operation of a motor while preserving high torque operation at low speeds and it does this while eliminating the need for higher voltage batteries. It adds only the required amount of power conversion and no more. It is also fault tolerant as can be seen from FIG. 2: should control system 66 fail or transistor 64 fail, the battery still has a direct path through inductance 54 and diode 62 to supply capacitor 68 and motor drive 16. With other boost converter topologies a bypass switch can be used.

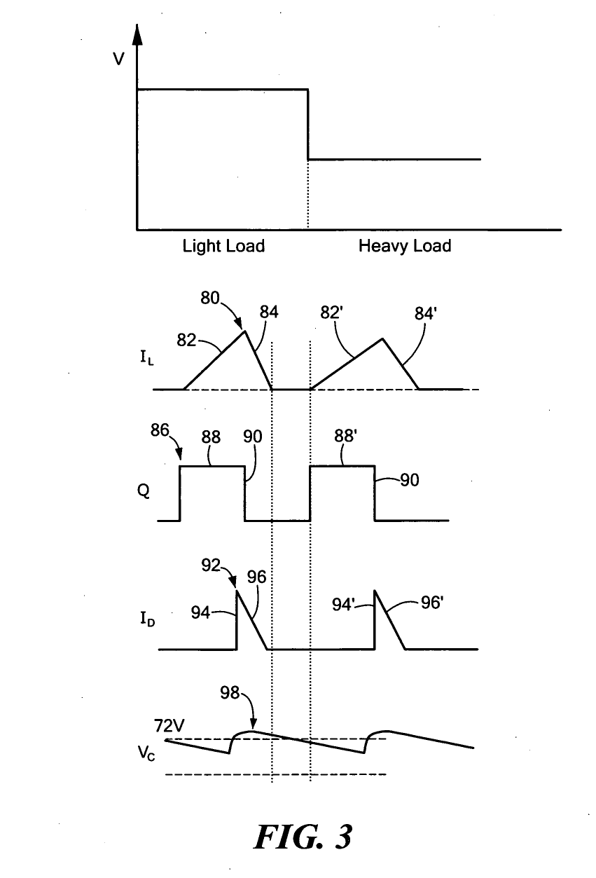

The operation of boost converter 50, FIG. 2, is demonstrated using the wave forms shown in FIG. 3, where the current I₁, 80 charges up, 82, when transistor 64 is turned on and then discharges, 84, when transistor 64 is turned off. This charging and discharging of inductance 54 is a function of the drive signal to transistor 64 shown at 86 where the positive 88 or on-time of transistor 64 coincides with the charging cycle 82 of inductance 54 and the off-time 90 begins the discharge of inductance 54 which occurs well before the onset of the next on time. The charging and discharging of inductance 54 in this way provides a current through I_{d}, 92, through diode 62 in the form of a fast rising leading edge 94 and a more slowing falling lagging edge 96. It is these pulses that charge capacitor 68 producing the boost level voltage V_{c}, e.g. 72 volts, to motor drive 16. V_{c} waveform 98 shows a fairly smooth but somewhat rippled characteristic due to the filtering effects of capacitor 68.

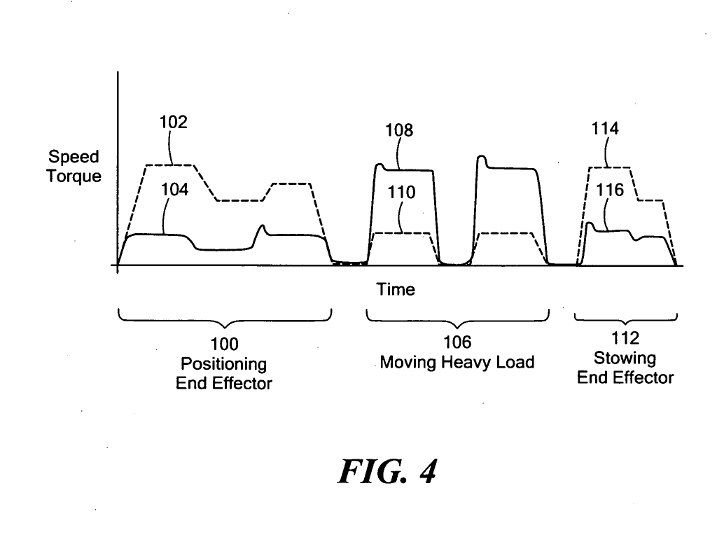

The tradeoff of speed for torque is illustrated in FIG. 4, where for a first period of time 100, the end effector is being positioned with no real load on it. The speed 102 can be very high due to the boost level voltage being high while during that same period the torque requirement 104 is quite low. In the next period of time 106, when the end effector and the arms are moving a heavy load, the torque is very high 108, but the speed 110 can and should be quite low. Finally, in the third period 112, after the load has been moved, the end effector is stowed, here again with a no-load or light-load condition the speed can be very high 114 while the torque 116 again will be low.

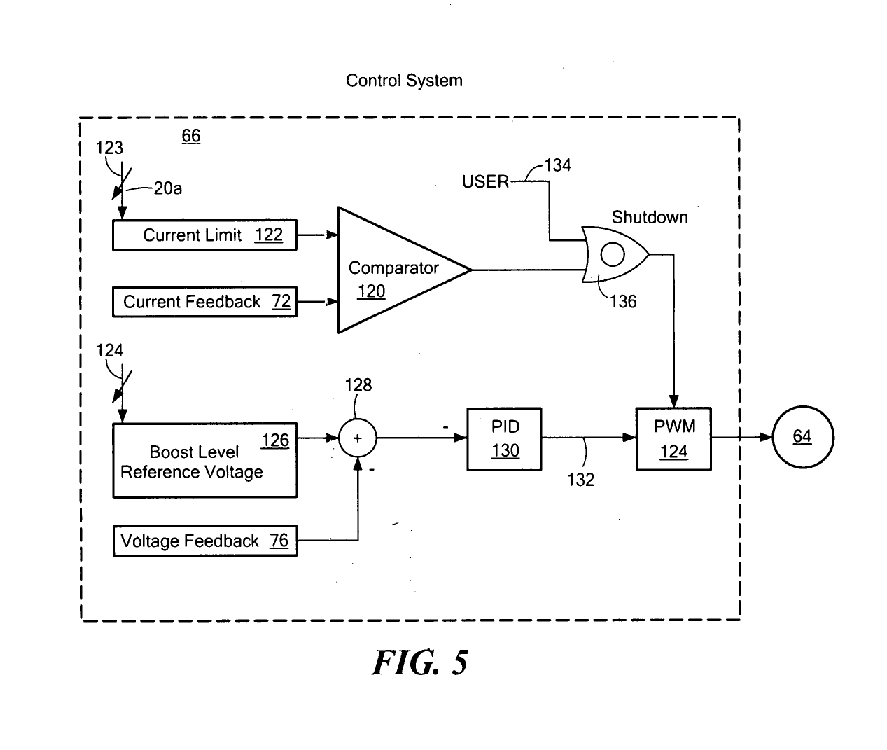

Control system 66, FIG. 5, may include a first comparator 120, which responds to the current feedback on line 72 and compares it to a preset current limit 122, for example, 20 amps. When the current feedback on line 72 exceeds that current limit 122, comparator 120 provides an output to pulse width modulator 124 to shut off transistor 64. Up until that time the pulse width modulator operates transistor 64 as previously explained. Also up until that limit is reached the boost level voltage, V_{c}, is maintained at the proper level e.g. 72 volts, by comparing the voltage feedback on line 76 with a boost level reference voltage 126 e.g. 72 volts and a second comparator 128 which may simply be a summing circuit as indicated. Any difference between the voltage feedback on line 76 and the boost level reference voltage 126 causes proportional integral derivative circuit 130 to provide a signal on line 132 to increase or decrease accordingly the pulse width of the gating signals provided by pulse width modulator 124 to the gate of transistor 64. When the voltage feedback is higher than the boost level reference the proportional integral derivative circuit 130 input will be negative and the duty cycle will be decreased. When the voltage feedback signal is lower than the boost level reference the proportional integral derivative 130 circuit will be positive and the duty cycle will be increased. Proportional integral derivative circuits are well known and do not form a part of this invention. For further efficiency, pulse width modulator 124 may be shut down at any time via a user command on line 134 through OR GATE 136. The actual current limit 122 need not be fixed but can be varied as indicated at 123. Likewise the boost level reference voltage 126 need not be fixed but may be varied as indicated at 124. This permits a continuum of complementary torque/speed (curve/voltage) ratios available to the system.

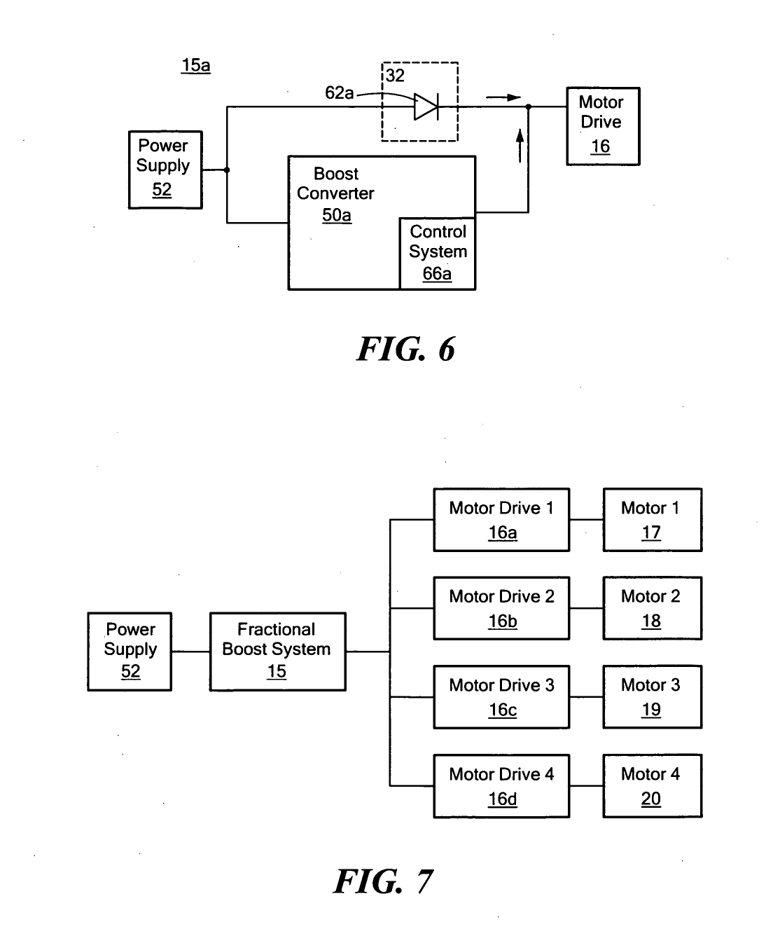

In another embodiment of the fractional boost system 15a according to this invention, the boost converter 50a, FIG. 6, is not simply on or off. Here boost converter 50a, which may includes in it control system 66a, may operate, for example, to provide the boost level voltage, V_{c}, at up to some predetermined current level. When that predetermined current level is exceeded control system 66a does not simply turn off boost converter 50a, rather it leaves it on, still providing its level of current up to but not exceeding the predetermined level. As more and more current is demanded by the motor drive 16 the voltage output from boost converter 50a will drop. When it drops below the base level voltage of power supply 52, then power supply 52 will begin providing additional current as required and its voltage e.g. 36 volts will now be the voltage output to motor drive 16. This embodiment too is fault tolerant as can be seen by the fact that, even if boost converter 50a fails of its own accord or some external problems, power supply 52 would still be available through diode 62a to supply motor drive 16. In practice this diode can be replaced by other components.

While the fractional boost system 15 of FIGS. 2 and 6 show but a single motor drive 16 this is not a limitation of the invention, for as shown in FIG. 7, fractional boost system 15 may provide a number of motor drives 16a-d each of which drives one of a plurality of motors 17, 18, 19, and 20 so that the single fractional boost system 15 of FIG. 1 can actually drive a plurality of motors drives 16 for a plurality of motors 17, 18, 19, 20, for example.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A fractional boost system comprising:
a boost converter, responsive to the base level voltage of a power supply, for providing a boost level voltage to a load; and
a control system for sensing the current to the boost converter and limiting the boost function of said boost converter when the current to the boost converter exceeds a predetermined level, while applying the power supply base level voltage and supplying current exceeding said predetermined level to the load.

2. The fractional boost system of claim 1 in which said control system disables the boost function of said boost converter when the current to said boost converter exceeds said predetermined level while enabling the boost converter to apply the power supply base level voltage and supply current exceeding said predetermined level to the load.

3. The fractional boost system of claim 1 in which said control system limits the current to said boost converter to no more than said predetermined current level while providing additional current to the load from the power supply at the base level voltage.

4. The fractional boost system of claim 3 in which said control system includes a switch device in parallel with said boost converter for enabling current flow from said power supply only when the boost level voltage decreased below said base level voltage.

5. The fractional boost system of claim 1 in which said control system includes a current sensor for sensing the current to said boost converter and a first comparator for determining whether the current to the boost converter exceeds said predetermined level.

6. The fractional boost system of claim 1 in which said control system includes a voltage sensor for sensing the voltage at the load and a second comparator circuit for determining any difference between the voltage at the load and said boost level voltage.

7. The fractional boost system of claim 6 in which said control system includes a proportional integral derivative circuit responsive to said second comparator circuit for providing an output representative of any said difference between the voltage at the load and said boost level voltage.

8. The fractional boost system of claim 6 or 7 further including a pulse width modulator responsive to said first and second comparator for setting the duty cycle of said boost converter.

9. The fractional boost system of claim 1 in which the load includes a motor drive.

10. The fractional boost system of claim 1 in which the load includes a number of motor drives.

11. The fractional boost system of claim 9 or 10 in which said motor drive(s) are in a mobile robot.

12. A fractional boost system for a motor drive comprising:
a boost converter, responsive to the base level voltage of a power supply, for providing a boost level voltage to a load; and
a control system for sensing the current to the boost converter and limiting the boost function of said boost converter when the current to the boost converter exceeds a predetermined level, while applying the power supply based level voltage and supplying current exceeding said predetermined level to the load.

13. A fractional boost system operating one or more motor drives of a remote controlled mobile robot comprising:
a boost converter, responsive to the base level voltage of a power supply, for providing a boost level voltage to a load; and
a control system for sensing the current to the boost converter and limiting the boost function of said boost converter when the current to the boost converter exceeds a predetermined level, while applying the power supply based level voltage and supplying current exceeding said predetermined level to the load.

14. A fractional boost system for a motor drive comprising:
a boost converter, responsive to the base level voltage of a power supply, for providing a boost level voltage to a load; and
a control system for sensing the current to the boost converter and limiting the boost function of said boost converter when the current to the boost converter exceeds a predetermined level, while applying the power supply based level voltage and supplying current exceeding said predetermined level to the load; said control system disabling the boost function of said boost converter when the current to said boost converter exceeds said predetermined level while enabling the boost converter to apply the power supply base level voltage and supply current exceeding said predetermined level to the load.

15. A fractional boost system operating one or more motor drives of a remote controlled mobile robot comprising:
a boost converter, responsive to the base level voltage of a power supply, for providing a boost level voltage to a load; and
a control system for sensing the current to the boost converter and limiting the boost function of said boost converter when the current to the boost converter exceeds a predetermined level, while applying the power supply based level voltage and supplying current exceeding said predetermined level to the load; said control system limiting the current to said boost converter to no more than said predetermined current level while providing additional current to the load from the power supply at the base level voltage.
